(19) United States
(12) Patent Application Publication
(10) Pub. No.: US 2010/0303307 A1
(43) Pub. Date: Dec. 2, 2010

(54) SYSTEM AND METHOD FOR POSITIVELY ESTABLISHING IDENTITY OF AN INDIVIDUAL WITH AN ELECTRONIC INFORMATION CARRIER

(75) Inventor: Leigh M. Rothschild, Sunny Isles Beach, FL (US)

Correspondence Address: HESPOS & PORCO LLP, 110 West 40th Street, Suite 2501, NEW YORK, NY, 10018, US

(73) Assignee: REAGAN INVENTIONS, LLC, Sunny Isles Beach, FL (US)

(21) Appl. No.: 12/855,033

(22) Filed: Aug. 12, 2010

Related U.S. Application Data
(63) Continuation of application No. 11/592,405, filed on Nov. 3, 2006.

(51) Int. Cl. G06K 9/00

(52) U.S. Cl. 382/116; 382/115

(57) ABSTRACT

A device, system and method for positively establishing an identity of an individual is provided. The device, system and method of the present disclosure provides for coupling an electronic information carrier to a reader device; receiving in the reader device at least one biometric identifier from the electronic information carrier; taking a biometric measurement of the individual; and comparing the at least one biometric identifier to the biometric measurement, wherein if the biometric measurement matches the biometric identifier, positively establishing the identity of the individual. Once the individual's identity is established, data such as a medical record may be access from the electronic information carrier. Furthermore, the record may be updated and written to the electronic information carrier. The biometric identifier may be a photo, a fingerprint, a hand geometry print, an iris scan, a retinal scan or a DNA fingerprint.

### PRIORITY

The present application is a continuation application of U.S. patent application Ser. No. 11/592,405, filed Nov. 3, 2006, the contents of which are hereby incorporated by reference in their entirety.

### BACKGROUND

1. Field

The present disclosure relates generally to medical record retrieval systems and individual identification systems, and more particularly, to devices, systems and methods for positively or negatively establishing the identity of an individual who has in their possession an electronic information carrier or digital identification tag.

2. Description of the Related Art

Digital Identification tags are now commonly used to store information pertaining to an individual's identity and other corollary information. Many companies produce such tags for a variety of applications. Such companies include PerfecTech, LLC of Dallas, Tex., SanDisk Corporation of Milpitas, Calif. and Irvine Sensors Corporation of Costa Mesa, Calif. to name a few.

The products have many brand and acronym names including Personal Information Carrier (PIC) and Wireless Electronic Information Carrier (WEIC). The two acronyms describe two types of product offering that the US Military's announced goal of creating a Military Electronic Health Record as part of its health care information system known as the AHLTA (Armed Forces Health Longitudinal Technology Application) program.

The first product offering the PIC, is an identification tag that is designed to contain digital information within the tag in resident flash memory. The tag can then be read by a peripheral device such as a Personal Digital Assistant. In fact, the military has a device they have created and tested to read these tags called the Battlefield Medical Information System Telemedicine (BMIST). The PIC will be read by physically locating the PIC and connecting it to the peripheral reader device (such as the BMIST). The peripheral reader device then interrogates the memory of the PIC and the PIC memory can be both read and written to. After usage, the person using the PIC (e.g., an inquiring person or IP) would detach it from the peripheral device and normally put it back on the person where they had found it.

The second product offering (WEIC) is very similar to the PIC with the exception that it does not need to be attached to the peripheral reader device. Instead, the WEIC can be read by the peripheral reader device wirelessly and generally within 2 to 10 meters from the patient. The peripheral reader device (including the BMIST) interrogates the WEIC and the peripheral reader device can both read and write to the memory of the WEIC. Alternatively, in cases where wireless communication cannot be established, the WEIC can be physically attached to the peripheral reader device and would have similar functionality to the PIC.

As discussed, the WEIC and PIC are designed to be used by US Military Personnel and may be used in combat conditions. The objective of these devices, along with the BMIST and other peripheral devices, is to allow ease of transfer of vital medical records and other information, and based on that information to provide medical treatment or to perform other logistical operations. Thus, it is vital for the positive identity of the user to be conclusively established with both the WEIC and PIC, along with any other digital identity tags. However, the current system of operation does not allow a user of a peripheral reader device including the BMIST to conclusively establish that the digital tag that is being read is the correct tag for the human that possesses the tag. In the case of both PIC and WEIC tags as well as other digital identity tags, the tags were designed to be either worn on the human or in some cases to be kept in or on the clothing or accessories (e.g., backpacks, etc) that the human has with him. However, the military has published articles that state that in many cases their personnel do not have the tags in a place that is expected, and in other cases combat conditions will separate the tags from the individual. In the case where the military personnel are in close proximity and in a combat situation, it is possible and in many cases likely that these tags will become undone and a tag will be in close proximity to a person that it does not belong to. There are also situations where tags could be intentionally attached to the wrong personnel (such as an enemy combatant moving the tags of wounded soldiers to confuse the medics).

A battlefield situation is not the only situation that tags can become removed and then associated with the wrong person. In a hospital environment whether military or civilian, the PIC tags and to some degree the WEIC tags will be removed from the patient to be read. (WEIC tags will be removed when the wireless capability is not functioning, or the tag needs inspection or repair, etc.) Human error will make it likely that in some cases the tag will not be placed back on the correct patient and thus the next person to read the tags will have incorrect information. Thus, it is imperative that the digital tags be correctly identified and associated with the proper person to whom they have been issued. Furthermore, there are also situations where the digital identification tag cannot be located or, if located, cannot be accessed by the peripheral reader device.

Therefore, a need exists for a system and method of positively confirming or denying an identity of an individual possessing a digital identification tag.

### SUMMARY

A system and method for positively establishing an identity of an individual is provided.

According to an aspect of the present disclosure, a method for positively establishing an identity of an individual is provided. The method includes coupling an electronic information carrier to a reader device; receiving in the reader device at least one biometric identifier from the electronic information carrier; taking a biometric measurement of the individual; and comparing the at least one biometric identifier to the biometric measurement, wherein if the biometric measurement matches the biometric identifier, positively establishing the identity of the individual. Once the individual's identity is established, data such as a medical record may be accessed from the electronic information carrier. Furthermore, the record may be updated and written to the electronic information carrier. The biometric identifier may be a photo, a fingerprint, a hand geometry print, an iris scan, a retinal scan or a DNA fingerprint.

According to another aspect, an electronic information carrier for storing at least one medical record of an individual includes at least one first memory configured to store at least one data record of the individual; and at least one second memory configured to store at least one biometric identifier of the individual. The electronic information carrier further includes a transmission interface configured for interfacing a reader device, wherein the transmission interface is of a contact or contactless type.

In a further aspect, a reader device for positively establishing the identity of an individual is provided. The reader device includes a transmission module configured for interfacing with an electronic information carrier and receiving at least one biometric identifier from the electronic information carrier; an identity capture device configured for taking a biometric measurement of the individual; and a verification module configured to compare the biometric identifier with the biometric measurement, wherein if the biometric identifier matches the biometric measurement, a processor is configured for retrieving at least one record of the individual on the electronic information carrier.

In another aspect, the reader device includes a communication module configured for transmitting the biometric measurement to a remote server and for receiving the at least one record from the remote server.

In yet a further aspect, the reader device includes a locational information module configured for determining a location of the reader device; a communication module configured for transmitting the reader device location to a remote server and for receiving from the remote server a plurality of records based on the reader device location, each of the plurality of records including a biometric identifier and an identity of an individual; and the verification module further configured to compare the biometric measurement with the biometric identifiers of the plurality of records.

In another aspect of the present disclosure, a system for positively establishing an identity of an individual includes an electronic information carrier for storing at least one medical record of an individual, the electronic information carrier including at least one first memory configured to store at least one data record of the individual and at least one second memory configured to store at least one biometric identifier of the individual; and a reader device for positively establishing the identity of an individual including a transmission module configured for interfacing with the electronic information carrier and receiving the at least one biometric identifier from the electronic information carrier; an identity capture device configured for taking a biometric measurement of the individual; and a verification module configured to compare the biometric identifier with the biometric measurement, wherein if the biometric identifier matches the biometric measurement, a processor is configured for retrieving the at least one record of the individual from the electronic information carrier.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 illustrates a system for positively establishing an identity of an individual possessing an electronic information carrier in accordance with the present disclosure;

FIG. 2 is a block diagram of an electronic information carrier in accordance with the present disclosure;

FIG. 3A is front view of a reader device for reading information from an electronic information carrier according to an embodiment of the present disclosure;

FIG. 3B is a rear view of the reader device shown in FIG. 3A;

FIG. 4 is a block diagram of various modules included in the reader device illustrated in FIGS. 3A and 3B;

FIG. 5A is a flow diagram illustrating a method for positively establishing an identity of an individual possessing an electronic information carrier in accordance with the present disclosure;

FIG. 5B is a flow diagram illustrating a method for establishing an identity of an individual without the use of an electronic information carrier in accordance with the present disclosure; and

FIG. 6 illustrates a system for establishing an identity of an individual without the use of an electronic information carrier in accordance with the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A system and method for positively establishing an identity of an individual is provided.

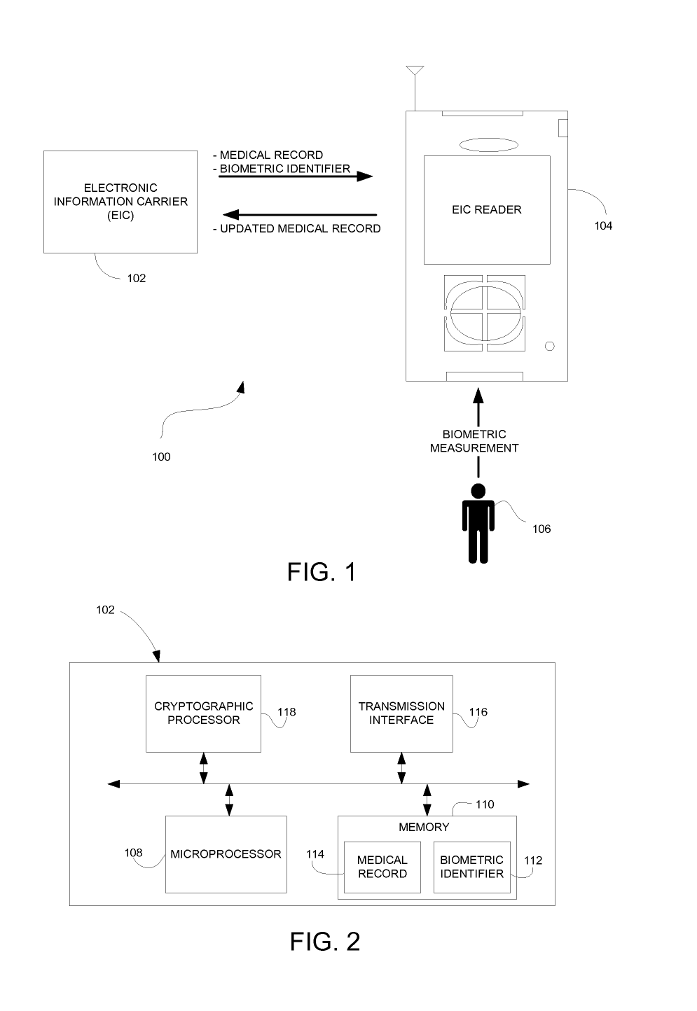

Referring to FIG. 1, a system 100 for positively establishing an identity of an individual is illustrated. The system 100 includes an electronic information carrier (EIC) 102 for storing at least one biometric identifier and at least one record, e.g., a medical record, of an individual 106 assigned to the EIC 102. The system also includes a reader device 104 for reading the at least one biometric identifier and the at least one medical record from the EIC and writing an updated version of the medical record to the EIC 102. When in communication (either wired or wireless) with the EIC, the reader device 104 will read the biometric identifier of an individual 106 assigned to the EIC 102. The reader device 104 will then take a biometric measurement of the individual and will compare the biometric measurement to the biometric identifier. If there is a match, the reader device 104 will be given access to the medial record of the individual on the EIC 102. It is to be appreciated that although the embodiments described herein employ a medical record as the data record other records relating to an individual may be used in accordance with the principles of the present disclosure such as but not limited to a personnel record, family history record, bank account records, education records, etc.

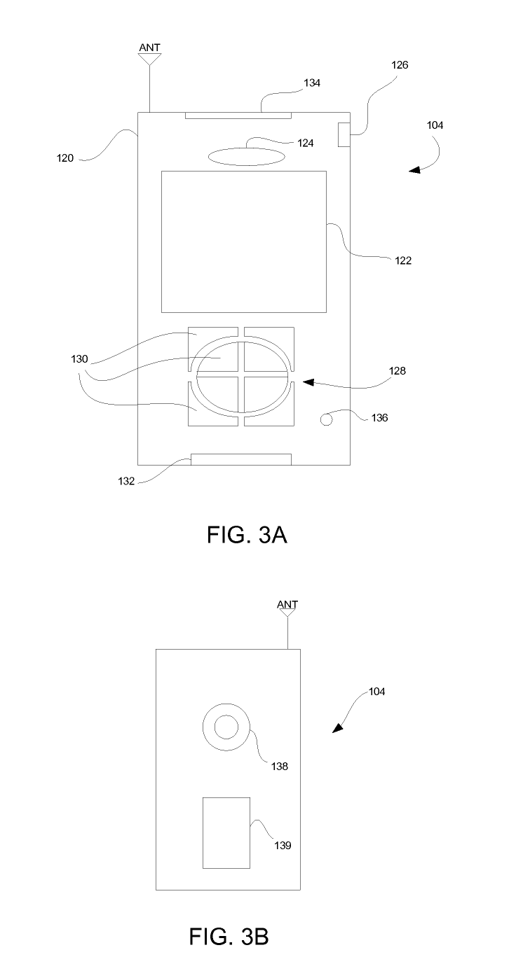

A block diagram of an electronic information carrier (EIC) 102 in accordance with the present disclosure is illustrated in FIG. 2. The EIC 102 includes a microprocessor 108 for controlling the overall operation of the EIC 102 and includes an operating system and applications for processing and manipulating data. Memory 110 is provided for storing at least one biometric identifier 112 and at least one medical record 114 of the individual assigned to the EIC 102. As will be described in more detail below, the at least one biometric identifier 112 will include but is not limited to a fingerprint, an iris pattern map, a photo, a DNA fingerprint, etc. The at least one medical record 114 will include but is not limited to blood type, pre-existing conditions, x-ray images, EKG readings, allergy information, last date treated, etc. The EIC 102 will interact with the reader device 104 via a transmission interface 116. The transmission interface 116 may be of the contact or contactless type. For the contact type interface, the EIC 102 will come into physical contact with the reader device 104 and the transmission interface 116 may include contact terminals, a USB connector or any other known types of hardware connector. For the contactless type interface, the EIC 102 will communicate to the reader device by wireless transmission and the transmission interface 116 may include an antenna, a wireless transceiver operating under a wireless protocol such as Bluetooth or IEEE 802 or any other wireless transmission means.

In one embodiment, the microprocessor 108 will include cryptographic algorithms to grant or deny access to the medical records 114 stored in memory 110. In other embodiments, the EIC 102 will include a separate cryptographic processor 118 for ciphering and deciphering the information store in memory 110 which will reduce the burden on microprocessor 108.

It is to be appreciated that the EIC 102 provided above, in certain embodiments, may be configured as a smart card in accordance with the International Standards Organization (ISO) standard 7810 and/or 7816 and other currently developing protocols. In the smart card configurations, the EIC 102 will include the microprocessor 108 and memory 110 or may just include the memory 110. It is further to be appreciated that the EIC 102 may be a dual-interface card that implement contactless and contact interfaces on a single card with some shared storage and processing. It is further to be appreciated that the EIC 102 may be configured in various shapes and sizes, e.g., as a dog tag worn around an individual's neck, as part of a bracelet worn on a wrist, etc.

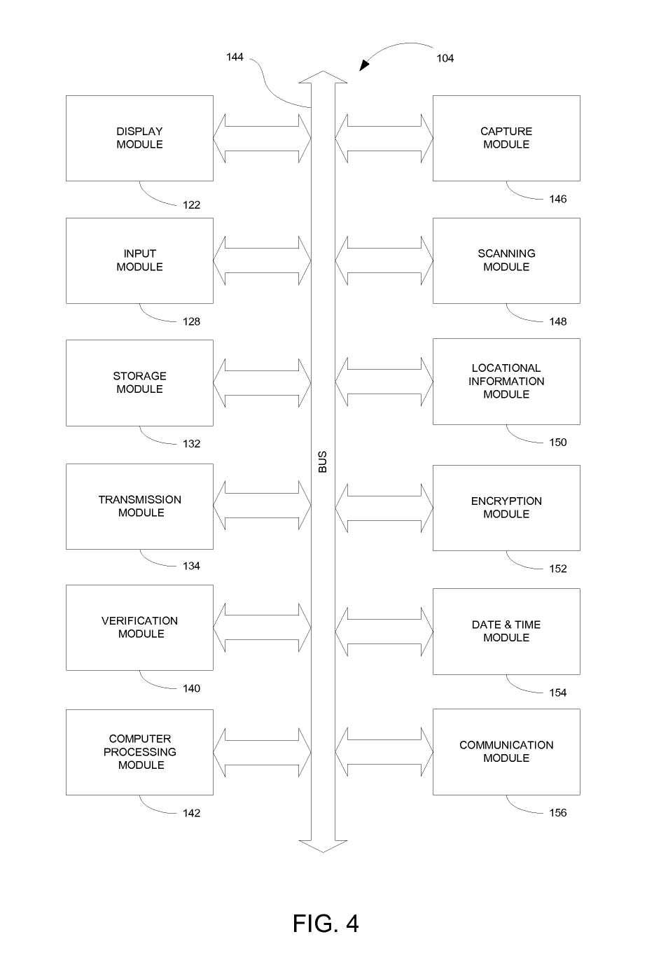

Referring to FIG. 3A, a reader device 104 for retrieving at least one medical record from an electronic information carrier and positively establishing an identity of an individual in accordance with an embodiment of the present disclosure is illustrated. The reader device 104 includes various electrical components, which will be described in detail below, disposed in a generally rectangular housing 120. A display module 122 is provided for displaying text and image media content, such as a medical record, x-ray images, etc. and a speaker 124 is provided configured to produce audio, e.g., treatment instructions. An audio port 126 will be configured to receive a plug or connector from a headphone, stereo system, etc. to stream the audio to the connected device. It is to be appreciated that when an external device is connected to the audio port 126 the speaker 124 will be disabled. Input module 128 includes a plurality of buttons 130 for inputting data and navigating through a plurality of menus. A touch screen overlaid upon the display module 122 may also be coupled to the input module for facilitating user input. The reader device 104 further includes a storage module 132 for storing a plurality of data and algorithms, e.g., cryptography algorithms, and a transmission module 134 for transmitting/receiving data to an electronic information carrier 102. Optionally, the reader device 104 may include a microphone 136 for acquiring audio from the user of the device to input data.

Referring to FIG. 3B, a rear view of the reader device 104 is illustrated. The reader device 104 will include a lens and image sensor 138 and a identity capture device 139 which will be described in detail below.

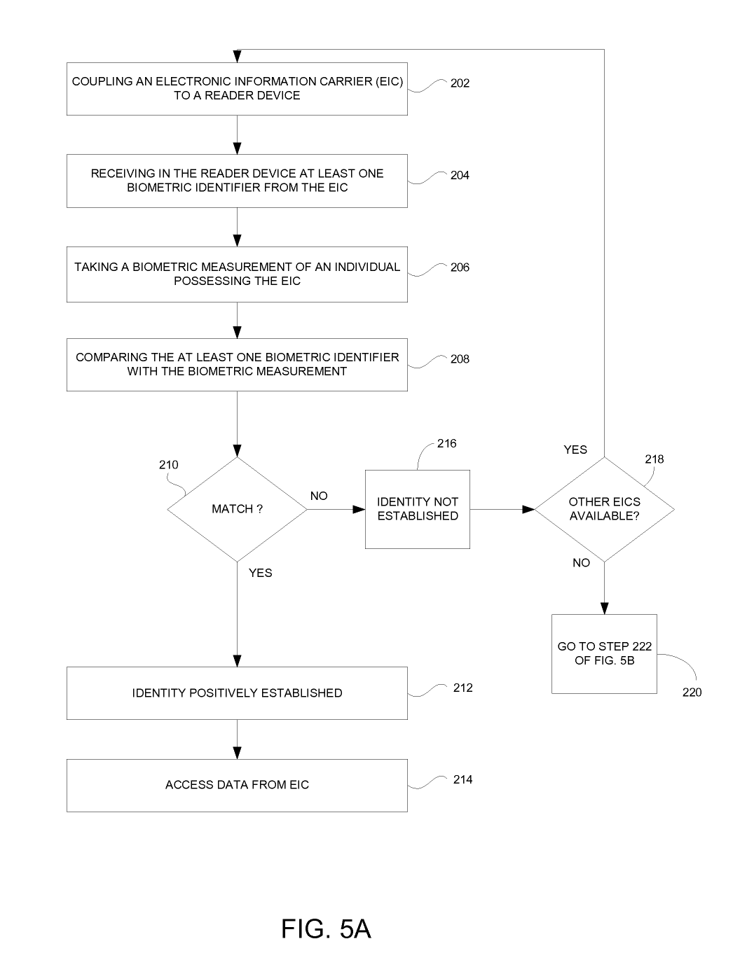

Referring to FIG. 4, the various components of the reader device 104 will now be described. The device will contain a computer processing module 142, e.g., a microprocessor. The computer processing module 142 will use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 144 couples the various components shown in FIG. 4 and may be any of several types of bus structures including a memory bus or memory controller, a peripheral bus, and a local bus using any of a variety of bus architectures. The device also includes an operating system and micro instruction code preferably residing in read only memory (ROM) (not shown). The various processes and functions described herein may either be part of the micro instruction code or part of an application program (or a combination thereof) which is executed via the operating system. Exemplary operating systems include but are limited to SymbianOS, Windows Mobile/Windows CE, Palm OS, Linux, Blackberry OS, BREW, etc. which have been developed for mobile computing applications and can handle both data computing and communication applications, e.g., voice communications.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer processing module 142 may further include, in addition to a microprocessor, a digital signal processor (DSP) for decoding stored audio, video and photo files to be played on the reader device 104. As is known in the art, the DSP may include several known decompression algorithms for decompressing stored media content, e.g., a MP3 file. The device 104 of the present disclosure will support various file types including but not limited to Microsoft Windows Media Video files (.wmv), Microsoft Photo Story files (.asf), Microsoft Windows Media Audio files (.wma), MP3 audio files (.mp3), JPEG image files (.jpg, .jpeg, .jpe, .jfif), MPEG movie files (.mpeg, .mpg, .mpe, .m1v, .mp2v .mpeg2), Microsoft Recorded TV Show files (.dvr-ms), Microsoft Windows Video files (.avi) and Microsoft Windows Audio files (.wav).

The device 104 will also contain a display module 122 for displaying digital information such as video files, image files, text files, etc. This display may be in any current form in the art, including Liquid Crystal Displays (LCD), Light emitting diode displays (LED), Cathode Ray Tube Displays (CRT) or any other type of display currently existing or existing in the future. The display module 122 may also include an audio output device, e.g., a speaker 124, audio port 126, etc., allowing the user to also hear audio output from the device 104, e.g., audio associated with a video, a MP3 file, etc.

The reader device 104 of the present disclosure will contain a user input module 128 to either receive user instructions via text input by the way of buttons 130, a standard keyboard interface coupled to the device, or a character recognition capture device which translates user text input into alphanumeric characters. Preferably, the character recognition device is a touch screen which overlays the display module 122 and text is entered via a pen-like stylus. Such input devices are standard and currently available on many electronic devices including portable digital assistants (PDAs) and cellular telephones. Optionally, microphone 136 may be further coupled to the input module 128 for capturing any audio information spoken by the user and the input module will further include an analog-to-digital (A/D) converter for converting the spoken audio information into a digital format. Furthermore, the input module may include a voice recognition processor that translates the digital human voice into alpha numeric characters for user input. The user will utilize the user input module 128 to enter various data, for example, to initiate communication with a remote server, to enter treatment information, etc.

The storage module 132 includes internal storage memory, e.g., random access memory (RAM), or removable memory such as magnetic storage memory; optical storage memory, e.g., the various known types of CD and DVD media; solid-state storage memory, e.g., a CompactFlash card, a Memory Stick, SmartMedia card, MultiMediaCard (MMC), SD (Secure Digital) memory; or any other memory storage that exists currently or will exist in the future.

The transmission module 134 will enable the device 104 to transmit or transfer information to the electronic information carrier 102, e.g., biometric measurements, updated medical data, encryption/decryption keys, etc. The transmission module 134 will perform its functionality by hardwired and/or wireless connectivity. The hardwire connection may include but is not limited to hard wire cabling e.g., parallel or serial cables, USB cable, Firewire (1394 connectivity) cables, and the appropriate port or a PCMCIA slot. The wireless connection will operate under any of the various known wireless protocols including but not limited to Bluetooth™ interconnectivity, infrared connectivity, radio transmission connectivity including computer digital signal broadcasting and reception commonly referred to as Wi-Fi or 802.11.X (where x denotes the type of transmission), satellite transmission or any other type of communication protocols or systems currently existing or to be developed for wirelessly transmitting data. The transmission module 134 will compress and encode the encrypted information for transmission using any known wireless communication technology. In one embodiment, antenna ANT is coupled to the transmission module 134 for extending the wireless transmission range of the reader device 104.

A capture module 146 is provided to capture an image desired by the user in digital form, e.g., an image of an individual being treated. The capture module 146 includes an image sensor, an analog-to-digital (A/D) converter and a digital signal processor (DSP). Referring to FIG. 3B when a user desires to capture an image, the lens 138 disposed on a rear side of the device is aimed at a subject of the image and is used in conjunction with display module 122 for positioning a subject of the image in lieu of a viewfinder. Light is allowed to enter through the lens 138 and shine on the image sensor, e.g., a charge-coupled device (CCD) or complimentary metal-oxide semiconductor (CMOS). The image sensor includes preferably millions of photosensors, e.g., pixels, wherein each pixel absorbs the light and transforms the light into an electric charge proportional to the intensity of light. Each charge is transmitted to an A/D converter where the charge is converted into a digital value representing the color the pixel will be, e.g., representing different intensities of red, green and blue. The digital values are then passed to the digital signal processor which enhances the image, compresses it and then stores it in a digital file format in the storage module 132.

In other embodiments, the device 104 will further include an integrated scanning module 148 which is coupled to lens 138 for scanning an iris of an eye of the individual being treated. The scanning module 148 will work in conjunction with the capture module 146 to capture an image of the iris. In a further embodiment, the scanning module 148 will contain a light source, e.g., LED, and photocell coupled to the computer processing module 142, or alternatively, will includes a separate decoder engine that will decode the data received by the photocell for performing a retinal scan of the individual's eye.

The reader device 104 will also include a verification module 140. The verification module 140 will indicate and verify the identity of the individual 106 by comparing the biometric identifier retrieved from the EIC 102 with a biometric measurement. The verification module 140 is coupled to an identity capture device 139, either incorporated into the device such as shown in FIG. 3B or coupled externally via a cable, or coupled to at least one of the modules described above. The identity capture device 139 may be a biometric device, such as a retinal scanning device, finger print reader, facial recognition reader or another type of identity verification input device which will collect a biometric measurement of the individual to be compared to information that has previously been stored in the device's memory, e.g., the biometric identifier. One such exemplary fingerprint reader is the BioTouch™ fingerprint reader commercially available from Identix Incorporated of Minnetonka, Minn. It is to be noted that identity detection devices such as biometric devices are common and are currently widely in use. It is to be further noted, that identity verification devices that are not yet in common use such as DNA detection, etc, would also be compatible with device 104. For example, a DNA detector will be included in reader device 104 and would sample a piece of hair, blood, salvia, etc to determine a DNA fingerprint of an individual. It is to be appreciated that the information utilized by the verification module 140 to verify an individual may be provided by other existing components of device 100 acting as the identity capture device, for example, capture module 146 may capture an image of the face of the individual which may then be processed by a facial recognition algorithm executed by the verification module 140. In this instance, no external hardware would be required. As another example, the capture module 146 may capture an image of an iris of the eye of the individual which may then be processed by a iris recognition algorithm executed by the verification module 140.

A locational information module 150 will be provided for determining a location of the reader device 104 where an individual is being treated. The locational information module 150 may include a receiver and antenna employing conventional locational information processing technology such as Global Positioning Satellite (GPS) Technology, Loran Technology, or any other available locational technology, to indicate the exact location, e.g., latitude, longitude and altitude, of the device 100 at the time of image capture. Exemplary GPS receivers and antennas are described in U.S. Pat. Nos. 5,654,718 and 6,775,612, the contents of both of which are herein incorporated by reference. It is to be appreciated that the latitude, longitude and altitude may be used to interact with maps stored in memory or in the storage module 132 of device 104 to determine the city, state or address of the location where the reader device 104 is located.

The device 100 will also include an encryption module 152. The encryption module 152 will use conventional code encryption algorithms currently in use or that will be in use in the future such as symmetric-key algorithms, e.g., DES, Triple-DES, Blowfish, RC2, RC4, RC5, etc, and asymmetric-key algorithms, e.g., Diffie-Hellman, RSA, ElGamal, etc. to decrypt the at least one medical record received from the electronic information carrier 102.

Furthermore, the device 100 will include a date and time module 154. The date and time module 154 will use standard computer chip processing technology widely in use, e.g., a crystal, or alternatively, input from a GPS receiver to supply the date and time.

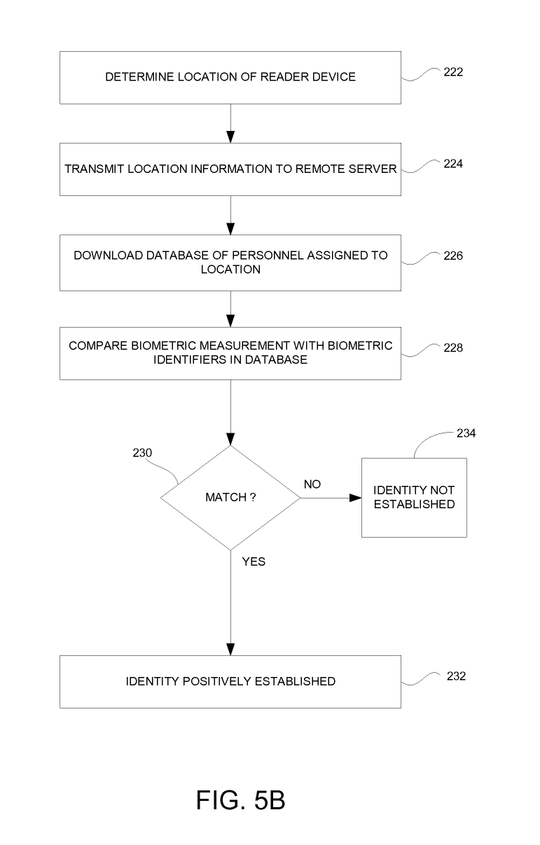

Referring to FIG. 5A, a method of positively identifying an individual possessing an electronic information carrier in accordance with the present disclosure is provided. Initially, an electronic information carrier (EIC) 102 is located. The EIC 102 may be readily located on the individual 106, e.g., around the individual's neck, or may be located by wireless transmission without physically touching the EIC 102. In step 202, an electronic information carrier (EIC) 102 is coupled to reader device 104. The EIC 102 may be coupled to the reader device 104 physically or via wireless transmission. In one embodiment, the EIC 102 will include a USB connector and will be inserted into a USB port of the reader device. In the embodiment where the EIC 102 is configured as a smart card, the EIC 102 will be inserted into the reader device 104 unit the contacts of the EIC 102 make contact with corresponding contacts of the reader device 104. In wireless embodiments, the reader device 104 will communicate with the EIC 102 according to at least the various protocols described above.

After the reader device 104 has established communications with the EIC 102, the reader device 104 will retrieve at least one biometric identifier of the individual assigned the EIC 102 from the memory 110 of the EIC 102 (step 204). The biometric identifier may include but is not limited to a photo, a fingerprint, a hand geometry print, an iris scan, a retinal scan, etc. The display module 122 will then indicate to a user, i.e., an inquiring person, of the reader device 104 what biometric identifier is available or simply provide instructions to the user what biometric measurement to take.

In step 206, the user, i.e., an inquiring person, will use the reader device 104 to take a biometric measurement from the individual. Once the biometric measurement is received, the reader device 104 will compare the biometric identifier to the biometric measurement to determine if the EIC 102 belongs to the individual (step 208). In one embodiment, the user will take an image of the individual with the capture module 146 and the reader device 104 will compare the taken image with the image received from the EIC 102, i.e., the biometric identifier, using facial recognition algorithms. In another embodiment, the user will employ the capture module 146 to capture an iris pattern from the individual's eye and then the reader device 104 will compare the taken iris pattern with an iris pattern received from the EIC 102, i.e., the biometric identifier, using iris recognition algorithms. In a further embodiment, the user will employ the scanning module 148 to capture a retinal map from the individual's eye and then the reader device 104 will compare the taken retinal map with a retinal map received from the EIC 102, i.e., the biometric identifier, using retinal recognition algorithms. In even further embodiments, the user will employ the verification module to capture a fingerprint or hand geometry print of the individual and then the reader device 104 will compare the taken print with the biometric identifier received from the EIC 102 using either fingerprint and/or hand geometry recognition algorithms. In yet another embodiment, the user will employ the verification module to capture a DNA sample of the individual, e.g., a hair sample, blood sample, saliva sample, etc., and then the reader device 104 will compare the taken DNA sample with the biometric identifier received from the EIC 102 using either DNA matching algorithms.

In step 210, the reader device 104 will determine if there is a match between the biometric identifier and the biometric measurement. If a match is confirmed, the individual's identity is positively established (step 212). Once the individual's identity is established, the reader device 104 will be able to access the data, e.g., the at least one medical record, on the EIC 102. In one embodiment, the data will be uploaded to and unencrypted in the reader device. In another embodiment, once a match is confirmed, the reader device 104 will transmit a key to the EIC 102 which will grant access to the data stored in the memory 110 of the EIC 102. In other embodiments, the key will be employed by the microprocessor 108 and/or the cryptographic processor 118 to decrypt the data. Furthermore, once the identity of the individual is confirmed, the medical records retrieved from the EIC 102 may be updated and/or added to and written back into the memory 110 of the EIC 102.

If at step 210, the reader device 104 determines there is not a match, the reader device 104 will indicate to the user that the individual's identity is not established (step 216). The user will then determine if any other EICs are available to investigate (step 218). If other EICs 102 are available, the method will go to step 202 and be repeated. If no other EICs 102 are available, the user will attempt to establish the identity of the individual without using information from the EIC 102 by proceeding to FIG. 5B (step 220) as will be described below.

If no EIC is available to confirm the identity of the individual, the reader device 104 will attempt to match a biometric measurement of the individual to a database stored locally in the reader device 104. As described above, the reader device 104 will take a biometric measurement of the individual. The reader device 104 will then compare the biometric measurement to a plurality of biometric identifiers stored in storage module 132. If a match is found, the reader device 104 will present available information to the user via the display module 122. The available information may be all the information relating to the individual that would have been stored in the EIC 102 or a subset of information depending on the capacity of the storage module 132.

In a further embodiment, if no EIC is available to confirm the identity of the individual, the reader device 104 will attempt to match a biometric measurement of the individual to a database stored remotely from the reader device 104. In this embodiment, the reader device 104 will further include a communication module 156 for communicating to a network and/or remote computing device. The communication module 156 is coupled to antenna ANT to transmit and receive data from remote computing devices using CDMA, PCS, GSM, satellite or any other known wireless communication technology.

It is to be appreciated that the communication module 130 may include a single integrated circuit chip to perform data transfer and voice communications or a single module including a separate data transfer chip, e.g., a WiFi transceiver, and a separate voice communication chip, e.g., a CDMA chip. In one embodiment, the communication module will operate on the wireless GPRS (General Packet Radio Service) data protocol or a 3G protocol such as W-CDMA, CDMA2000 and TD-SCDMA. Both the GPRS and 3G protocols have the ability to carry both voice and data over the same service.

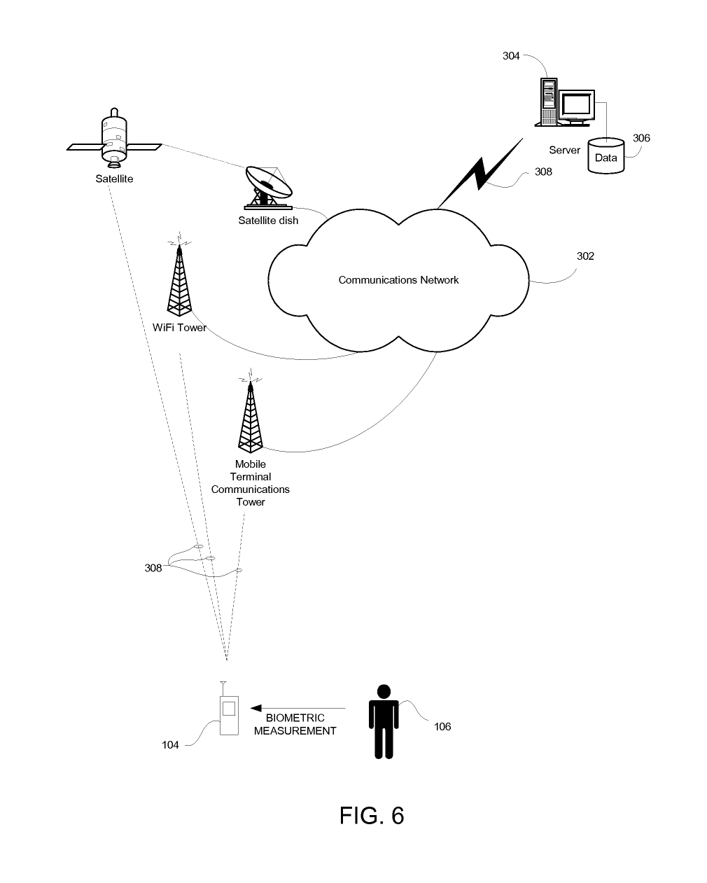

A system and method for identifying an individual 106 and retrieving at least one record relating to the individual over a network will be described in relation to FIGS. 5B and 6. Referring to FIG. 6, a system in accordance with the present disclosure is illustrated. The system includes the reader device 104 as described above. The device 104 will communicate to a server 304 via a communication network 302. The reader device 104 and server 304 may be connected to the communications network 302, e.g., the Internet, by any known means, for example, a hardwired or wireless connection 308, such as dial-up, hardwired, cable, DSL, satellite, cellular, PCS, wireless transmission (e.g., 802.11a/b/g), etc. It is to be appreciated that the network 302 may be a local area network (LAN), wide area network (WAN), the Internet or any known network that couples a plurality of computers to enable various modes of communication via network messages. Furthermore, the server 304 will communicate using the various known protocols such as Transmission Control Protocol/Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc. The server 304 will further include a storage medium 306 for storing a database of records of individuals. Each record in the database includes at least one biometric identifier, at least one medical record related to the biometric identifier and an identity of an individual relating to the at least one biometric identifier.

Referring to FIG. 5B, a user will initially indicate to the reader device 104 that a medical record for an individual is required, however, no EIC 102 is available. Due to the potential size of a database containing a large of number of records and the associated processing delay, the reader device will attempt to search a subset of the records available in database 306. In one embodiment, the reader device will search a subset of records for individuals who are assigned to a particular location, for example, military personnel assigned to a specific region. In this embodiment, the location of the reader device 104 will be determined via locational information module 150 (step 222). The location information of the reader device 104, e.g., location coordinates, will be transmitted using communications protocols including but not limited to WiFi (a, b, c d, n, x), mobile phone communications such as GSM, CDMA, FOMA, etc., infrared communications, cabled communications, Bluetooth communications, satellite communications, to the remote server 304 on the global computer network (GCN), e.g., the Internet (step 224). It is to be appreciated the device 104 may use any one or a combination protocols to transmit the location information to the server 304.

After the server 304 receives the location information of the reader device, the server 304 will determine the individuals or personal assigned to the region or location of the reader device. The server 304 will then download a subset database of personnel assigned to the determined location (step 226). The user of the reader device 104 will then take a biometric measurement of the individual and the reader device 104 will compare the biometric measurement to the biometric identifiers in the received database (step 228). The reader device will determine if there is a match in step 230. If it is determined that there is a match, the individual's identity will be positively established (step 232); otherwise, the individual's identity will not be established (step 234).

In a further embodiment, the biometric measurement will be transmitted to the remote server 304 and the remote server will return to the reader device 104 the medical record of the individual matching the biometric measurement.

The present disclosure will enable at least the following applications of the devices, systems and methods disclosed herein.

A medic has been called to attend to a soldier in a combat situation. The medic attempts to locate the individual's EIC but cannot. The medic finally locates the EIC near the soldier but cannot be sure that this EIC belongs to the soldier. The medic takes the EIC and couples the EIC to a reader device. The medic then takes the soldier's finger and places it on the identity capture device of the reader device. The reader device reads the biometric measurement of the soldier's finger and compares this biometric measurement to the biometric identifier on the EIC. The reader device confirms that this EIC belongs to the soldier. The medic then performs treatment to the soldier and reads and writes information to the EIC.

A medic has been called to attend a soldier in a combat situation. The medic attempts to locate the individual's EIC using his reader device and does locate the EIC which in this case has been blown off and is in close proximity to the wounded soldier. The medic places the soldier's finger on the reader device and the reader device reads the biometrics of the finger and compares that information to the biometric identifier that is being wirelessly transmitted from the EIC. In this case, the medic is told by the reader device that the EIC is not the EIC for this individual soldier. The medic must then search for the correct EIC for the wounded soldier.

A hospital attendant is attending to a patient. The attendant locates the individual's EIC and attaches it to a reader device. The hospital attendant then takes the patient's eye and points the reader device towards the eye. The reader device does a retinal and/or iris scan of the eye and compares this information to the biometric identifier stored on the EIC. The reader device confirms that this EIC belongs to the patient. The attendant then performs treatment to the patient and reads and writes information to the EIC.

In a combat situation, a medic tries to locate the EIC and finds that this device is destroyed. The military personnel's dog tag has also been rendered unreadable. The medic takes the soldier's finger and places it on the reader device. The reader device then takes the biometrics of the person and compares it to the biometric identifiers that are stored in stored memory on the reader device. In this case, the reader device locates the biometric identifier and associated record, identifies the soldier, and then provides basic information to the medic such as name, assignment of soldier, blood type, and any critical allergies. The medic is then able to treat the soldier. Alternatively, if the record of the soldier is not found in the database of the reader device, the reader device will transmit the biometric measurement and/or location information of the soldier to a remote server for locating the medical record of the soldier.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for positively establishing the identity of an individual, the method comprising:
taking at least one biometric measurement of the individual with a reader device;
comparing the at least one biometric measurement to a plurality of biometric identifiers stored in a database of the reader device; and
wherein if the biometric measurement matches the biometric identifier, retrieving at least one record of the individual, the at least one record including an identity of the individual.

2. The method as in claim 1, wherein the comparing step further comprises:
determining a location of the reader device; and
retrieving a database of records relating to individuals assigned to the determined location.

3. The method as in claim 2, wherein the location is determined by a GPS receiver.

4. The method as in claim 2, wherein the at least one record is at least one medical record of the individual.

5. The method as in claim 4, wherein the at least one record includes blood type, pre-existing conditions, x-ray images, EKG readings, DNA information, allergy information and last date treated.

6. The method as in claim 4, further comprising:
updating the at least one medical record; and
writing the at least one updated medical record to an electronic information carrier associated to the individual.

7. The method as in claim 6, wherein the at least one updated medical record is wirelessly written to the electronic information carrier.

8. The method as in claim 6, wherein the electronic information carrier is configured as a tag to be worn on the individual.

9. The method as in claim 6, further comprising encrypting the at least one updated medical record before writing to the electronic information carrier

10. The method as in claim 1, wherein the biometric identifier is a photo, a fingerprint, a hand geometry print, an iris scan, a retinal scan or a DNA fingerprint.

11. The method as in claim 1, wherein if the biometric measurement does not match the biometric identifier, further comprising:
transmitting the biometric measurement to a remote server;
receiving the at least one record from the remote server.

12. The method as in claim 2, wherein the at least one record is at least one bank account record of the individual.

13. A method for positively establishing the identity of an individual, the method comprising:
determining, by a locational information module, a location of a reader device;
transmitting, by the reader device, the determined location to a remote server, wherein the remote server determines a subset database of personnel assigned to the determined location;
receiving, from the remote server, the subset database;
taking at least one biometric measurement of the individual with a reader device;
comparing the at least one biometric measurement to a plurality of biometric identifiers in the subset database of the reader device; and
wherein if the biometric measurement matches at least one biometric identifier, establishing an identity of the individual.

14. The method as in claim 13, wherein the biometric identifier is a photo, a fingerprint, a hand geometry print, an iris scan, a retinal scan or a DNA fingerprint.

15. The method as is claim 13, wherein the biometric identifier is a DNA fingerprint and the at least one biometric measurement of the individual is a hair sample.

16. The method as is claim 13, wherein the biometric identifier is a DNA fingerprint and the at least one biometric measurement of the individual is a blood sample.

17. The method as is claim 13, wherein the biometric identifier is a DNA fingerprint and the at least one biometric measurement of the individual is a saliva sample.
